(19) United States
(12) Patent Application Publication
(10) Pub. No.: US 2025/0288137 A1
(43) Pub. Date: Sep. 18, 2025

(54) MAGNETIC CONNECTING ATTACHMENT, MAGNETIC CONNECTING ATTACHMENT ASSEMBLY AND CONTAINER

(71) Applicant: EVOLUTIVE LABS CO., LTD., Taipei City (TW)

(72) Inventors: Jui-Chen LU, Taichung City (TW); Cheng-Che HO, Taichung City (TW)

(73) Assignee: EVOLUTIVE LABS CO., LTD., Taipei City (TW)

(21) Appl. No.: 19/076,997

(22) Filed: Mar. 11, 2025

Related U.S. Application Data
(60) Provisional application No. 63/565,524, filed on Mar. 14, 2024.

(51) Int. Cl. A47G 19/22

(52) U.S. Cl. CPC A47G 19/2227; A47G 19/2272; A47G 2200/106

(57) ABSTRACT

A magnetic connecting attachment adapted for a container with an engaging feature and a mobile device is provided. The magnetic connecting attachment includes a connecting member and a magnetic connecting member. The connecting member has at least one engaging portion, and the engaging portion is adapted to engage with the engaging feature of the container. The magnetic connecting member is configured with the connecting member, and the magnetic connecting member is adapted to be magnetically connected to the mobile device. Besides, a lid assembly and a container assembly for beverages or food respectively include the magnetic connecting attachment are also provided.

### CROSS-REFERENCE TO RELATED APPLICATION

This non-provisional application claims priority under 35 U.S.C. § 119 (e) on US provisional Patent Application No(s). 63/565,524 filed on Mar. 14, 2024, the entire contents of which are hereby incorporated by reference.

### BACKGROUND OF THE INVENTION

### 1. Field of the Invention

The present disclosure provides a magnetic connecting attachment, a lid assembly, and a container assembly for beverages or food, and particularly relates to a magnetic connecting attachment that can magnetically connect a mobile device to a specific position, a lid assembly, and a container assembly for beverages or food.

### 2. Description of the Related Art

Kettles are daily items that are widely used by the public; the commonly available types of kettles in the market include vacuum insulated water bottles, ice master cups, straw cups, etc., which have different functions to meet the needs of different occasions. In addition, for the sake of environmental protection and health, water bottles that are made from safe materials and are reusable have become one of the must-haves for people to go out, just like mobile devices such as smartphones, smart watches, or tablet personal computers.

### BRIEF SUMMARY OF THE INVENTION

However, the above kettles do not provide the ability to hold the mobile device in place. When it is inconvenient for a user to hold the mobile device with a hand in a specific position, such as exercising, eating, or cooking while watching a video, or when it is necessary to take a photo or video of himself/herself, the user can only hold the mobile device against a stationary object, or purchase an item such as a mobile phone holder with a tripod to fix the mobile device; and consequently, the risk of collision damage to the mobile devices is increased, or the number of items to be carried when going out is increased, resulting in inconvenience.

In view of the above shortcomings, in order to achieve a perfect solution, the inventor conducts in-depth research and finally develops a magnetic connecting attachment that can magnetically connect the mobile device to a specific position, a lid assembly, and a container assembly for beverages or food, so as to reduce the risk of collision damage to the mobile device and reduce the number of items to be carried when going out.

The use of the quantifier of “a/an” or “one” in the elements and components described in the full text of the present disclosure is only for convenience and to provide the general meaning of the scope of the present disclosure. In the present disclosure, it should be interpreted as including one or at least one, and the concept of one also includes the condition of multiple, unless it is clearly indicated otherwise.

The similar terms such as “connecting”, “combining” or “assembling” mentioned in the full text of the present disclosure mainly include the forms that the components can be separated without destroying after being connected, or the components can be inseparable after being connected, and those of ordinary skill in the art can choose it according to the material or assembling requirements of the components to be connected.

In order to achieve the above and other objectives, the present disclosure provides a magnetic connecting attachment, adapted for a container for beverages or food and a mobile device, and the container for beverages or food is provided with an engaging feature; the magnetic connecting attachment includes a connecting member, having at least one engaging portion, the engaging portion being adapted to be engaged with the engaging feature of the container for beverages or food; and a magnetic connecting member, arranged at the connecting member and adapted to be magnetically connected to the mobile device.

In the magnetic connecting attachment, the container for beverages or food may be provided with a lid, and the engaging feature may be arranged on the lid.

In the magnetic connecting attachment, the connecting member is rotatably connected to the lid, the lid may include a top plate, the top plate may be provided with a communicating opening, the connecting member may include a main body and a communicating portion, and the main body may be located above the top plate; when the connecting member rotates to a communicating position, the communicating portion is adapted to be aligned with the communicating opening; and when the connecting member rotates to a shielding position, the main body is adapted to shield the communicating opening.

In the magnetic connecting attachment, the lid may include a top plate, the engaging feature may be an engaging opening penetrating through the top plate, the connecting member includes a main body, and the engaging portion may protrude out of a lower surface of the main body so as to be adapted to penetrate into the engaging opening.

In the magnetic connecting attachment, the engaging portion may include an extending portion and a hook portion, one end of the extending portion may be connected to the main body, and the hook portion may be connected to the extending portion and protrudes out of the outer circumferential surface of the extending portion; and the extending portion may penetrate through the engaging opening, and the hook portion may be located below the top plate.

In the magnetic connecting attachment, the engaging portion may be elastic and may be detachably connected to the engaging feature; and before the engaging portion is pressed and elastically deformed, an outer diameter of the extending portion may be substantially equal to a caliber of the engaging opening, and a maximum outer diameter of the hook portion may be larger than the caliber of the engaging opening.

In the magnetic connecting attachment, a space between a lower surface of the main body and an upper surface of the hook portion may be substantially equal to the thickness of the top plate.

In the magnetic connecting attachment, the connecting member may include a main body and a pivoting base; the pivoting base may be connected to the main body; and the magnetic connecting member may include a magnetic connecting portion and a pivoting portion, the magnetic connecting portion may be connected to the pivoting portion, and the pivoting portion is pivoted to the pivoting base.

In the magnetic connecting attachment, the lid may include a top plate and a ring wall, the ring wall is arranged on the periphery of the top plate, and the ring wall may form an accommodating cavity above the top plate in a surrounding mode; and when the magnetic connecting member is pivoted to a folded state, part or all of the magnetic connecting portion may be accommodated in the accommodating cavity.

In the magnetic connecting attachment, the lid may include a top plate and a ring wall, and the ring wall is arranged on the periphery of the top plate; and the pivoting portion may form a concave avoiding portion which is adapted to accommodate the ring wall when the magnetic connecting portion is pivoted to be adjacent to the ring wall.

In the magnetic connecting attachment, the main body may be provided with a slide groove, and the pivoting base is slidably arranged in the slide groove.

In the magnetic connecting attachment, the lid may include a top plate and a ring wall, and the ring wall is arranged on the periphery of the top plate; and the connecting member includes a main body, and two ends of the main body may form the engaging portion to be engaged with an inner side surface of the ring wall.

In the magnetic connecting attachment, the lid may include a top plate and a ring wall, and the ring wall is arranged on the periphery of the top plate and may form the engaging feature of the lid; and the connecting member includes a main body, and the engaging portion may be located at an end portion of the main body and adapted to be detachably connected to the ring wall.

In the magnetic connecting attachment, the engaging portion may be elastic and includes an extending portion and a hook portion, the extending portion may be in an inverted U shape corresponding to the form of the ring wall, one end of the extending portion may be connected to the main body, and the hook portion may be arranged at the other end of the extending portion.

In the magnetic connecting attachment, when the engaging portion is connected to the ring wall, the extending portion may be attached to an inner side surface, an upper edge, and an outer side surface of the ring wall, and the hook portion may be engaged to a lower edge of the ring wall.

In the magnetic connecting attachment, the container for beverages or food may be provided with a body portion and a lid; the lid is adapted to be arranged on the body portion, and the body portion may include a handle; the lid may include a top plate and a ring wall, the ring wall is arranged on the periphery of the top plate, and the handle and the ring wall may jointly form the engaging feature; the connecting member may include a main body, a pivoting base, an engaging portion, and a buckling portion, the pivoting base may be arranged on the main body, the engaging portion may be arranged on the main body or the pivoting base, an engaging groove may be formed between the engaging portion and the main body in a surrounding mode, and the engaging groove is adapted to allow the ring wall to interlock; and the buckling portion may be arranged on the main body, a buckling groove may be formed between the buckling portion and the main body in a surrounding mode, the buckling groove is adapted to allow the handle to interlock, and the opening direction of the engaging groove is different from that of the buckling groove.

In the magnetic connecting attachment, the magnetic connecting member includes a magnetic connecting portion, and the magnetic connecting portion may be of an annular structure and may form a through hole.

In the magnetic connecting attachment, the magnetic connecting member includes a magnetic connecting portion, and the shape of the magnetic connecting portion may correspond to a magnetic connecting feature of the mobile device.

In addition, the present disclosure further provides a lid assembly, adapted for a mobile device, and the lid assembly includes a lid, having an engaging feature; and a magnetic connecting attachment, including a connecting member, having at least one engaging portion, the engaging portion being adapted to be engaged with the engaging feature of the lid; and a magnetic connecting member, arranged at the connecting member and adapted to be magnetically connected to the mobile device.

In the lid assembly, the connecting member is rotatably connected to the lid, the lid may include a top plate, the top plate may be provided with a communicating opening, the connecting member may include a main body and a communicating portion, and the main body may be located above the top plate; when the connecting member rotates to a communicating position, the communicating portion is aligned with the communicating opening; and when the connecting member rotates to a shielding position, the main body shields the communicating opening.

In the lid assembly, the lid may include a top plate, the engaging feature may be an engaging opening penetrating through the top plate, the connecting member includes a main body, and the engaging portion may protrude out of a lower surface of the main body so as to be adapted to penetrate into the engaging opening.

In the lid assembly, the engaging portion may include an extending portion and a hook portion, one end of the extending portion may be connected to the main body, and the hook portion may be connected to the extending portion and protrudes out of the outer circumferential surface of the extending portion; and the extending portion may penetrate through the engaging opening, and the hook portion may be located below the top plate.

In the lid assembly, the engaging portion may be elastic and may be detachably connected to the engaging feature; and before the engaging portion is pressed and elastically deformed, an outer diameter of the extending portion may be substantially equal to a caliber of the engaging opening, and a maximum outer diameter of the hook portion may be larger than the caliber of the engaging opening.

In the lid assembly, a space between a lower surface of the main body and an upper surface of the hook portion may be substantially equal to the thickness of the top plate.

In the lid assembly, the connecting member may include a main body and a pivoting base; the pivoting base may be connected to the main body; and the magnetic connecting member may include a magnetic connecting portion and a pivoting portion, the magnetic connecting portion may be connected to the pivoting portion, and the pivoting portion is pivoted to the pivoting base.

In the lid assembly, the lid may include a top plate and a ring wall, the ring wall is arranged on the periphery of the top plate, and the ring wall may form an accommodating cavity above the top plate in a surrounding mode; and when the magnetic connecting member is pivoted to a folded state, part or all of the magnetic connecting portion may be accommodated in the accommodating cavity.

In the lid assembly, the lid may include a top plate and a ring wall, and the ring wall is arranged on the periphery of the top plate; and the pivoting portion may form a concave avoiding portion which is adapted to accommodate the ring wall when the magnetic connecting portion is pivoted to be adjacent to the ring wall.

In the lid assembly, the lid may include a top plate and a ring wall, and the ring wall is arranged on the periphery of the top plate; and the connecting member includes a main body, and two ends of the main body may form the engaging portion to be engaged with an inner side surface of the ring wall.

In the lid assembly, the lid may include a top plate and a ring wall, and the ring wall is arranged on the periphery of the top plate and may form the engaging feature of the lid; and the connecting member includes a main body, and the engaging portion may be located at the end portion of the main body and adapted to be detachably connected to the ring wall.

In the lid assembly, the engaging portion may be elastic and includes an extending portion and a hook portion, the extending portion may be in an inverted U shape corresponding to the form of the ring wall, one end of the extending portion may be connected to the main body, and the hook portion may be arranged at the other end of the extending portion.

In the lid assembly, when the engaging portion is connected to the ring wall, the extending portion may be attached to an inner side surface, an upper edge, and an outer side surface of the ring wall, and the hook portion may be engaged to a lower edge of the ring wall.

In the lid assembly, the lid is adapted to be arranged on a body portion of a container for beverages or food, and the body portion may include a handle; the lid may include a top plate and a ring wall, and the ring wall is arranged on the periphery of the top plate; the connecting member may include a main body, a pivoting base, an engaging portion, and a buckling portion, the pivoting base may be arranged on the main body, the engaging portion may be arranged on the main body or the pivoting base, an engaging groove may be formed between the engaging portion and the main body in a surrounding mode, and the engaging groove is adapted to allow the ring wall to interlock; and the buckling portion may be arranged on the main body, a buckling groove may be formed between the buckling portion and the main body in a surrounding mode, the buckling groove is adapted to allow the handle to interlock, and the opening direction of the engaging groove is different from that of the buckling groove.

In addition, the present disclosure further provides a container assembly for beverages or food, adapted for a mobile device; the container assembly for beverages or food includes a container for beverages or food, having an engaging feature; and a magnetic connecting attachment, including a connecting member, having at least one engaging portion, the engaging portion being adapted to be engaged with the engaging feature of the container for beverages or food; and a magnetic connecting member, arranged at the connecting member and adapted to be magnetically connected to the mobile device.

In the container assembly for beverages or food, the container for beverages or food is provided with a body portion and a lid, the lid is adapted to be arranged on the body portion, and the engaging feature is arranged on the lid.

Therefore, the container assembly for beverages or food according to the present disclosure has the functions of accommodating beverage or food and being used as a mobile device support and the like; and the mobile device can be stably and magnetically connected to the container assembly for beverages or food, so that the risk that the mobile device is damaged by collision can be effectively reduced. More importantly, the user only needs to carry the container assembly for beverages or food when going out, the mobile device can be stably supported when needed, a support does not need to be additionally carried for supporting the mobile device, thus the number of articles to be carried when the user goes out can be reduced, the problem that the use is inconvenient due to the fact that the user forgets to carry the support is solved, and remarkable benefits are achieved for improving the life convenience.

### BRIEF DESCRIPTION OF THE DRAWINGS

FIG. 1 is a schematic three-dimensional exploded view of Embodiment I of a container assembly for beverages or food according to the present disclosure.

FIG. 2 is a schematic three-dimensional view from another angle of view of a magnetic connecting attachment in FIG. 1.

FIG. 3 is a schematic top view of a lid and a magnetic connecting attachment in FIG. 1.

FIG. 4 is a schematic cross-sectional view taken along section A-A as indicated in FIG. 3.

FIG. 5 is a schematic cross-sectional view of another embodiment based on the perspective of FIG. 4.

FIG. 6 is a schematic cross-sectional view taken along section B-B as indicated in FIG. 3.

FIG. 7 is a schematic cross-sectional view showing a magnetic connecting attachment rotated to a shielding position based on the perspective of FIG. 6.

FIG. 8 is a schematic cross-sectional view showing a magnetic connecting member pivoted to a folded state based on the perspective of FIG. 7.

FIG. 9 is a schematic three-dimensional view of Embodiment II of a magnetic connecting attachment according to the present disclosure.

FIG. 10 is a schematic side section view of Embodiment II of a container assembly for beverages or food according to the present disclosure.

FIG. 11 is a schematic three-dimensional exploded view of Embodiment III of a container assembly for beverages or food according to the present disclosure.

FIG. 12 is a schematic front view of a magnetic connecting attachment in FIG. 11.

FIG. 13 is a schematic right view of a magnetic connecting attachment in FIG. 11.

FIG. 14 is a schematic view of an action of assembling a magnetic connecting attachment to a lid in FIG. 11.

FIG. 15 is a schematic view of an action of assembling a magnetic connecting attachment to a handle in FIG. 11.

### DETAILED DESCRIPTION OF THE INVENTION

In order to fully understand the objectives, characteristics and effects of the present disclosure, the present disclosure is described in detail by means of the following specific embodiments in cooperation with the accompanying drawing as follows:

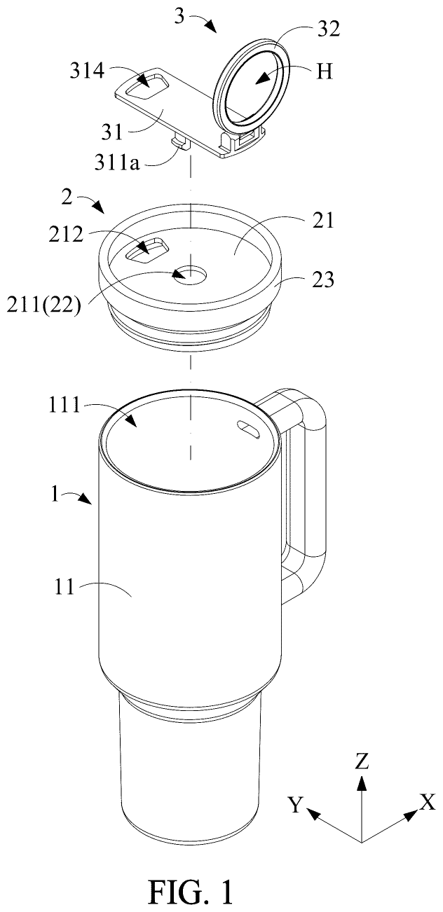

With reference to FIG. 1, it is Embodiment I of a container assembly for beverages or food according to the present disclosure. The container assembly for beverages or food includes a magnetic connecting attachment 3 and a container for beverages or food adapted for the magnetic connecting attachment 3. The container for beverages or food includes a body portion 1 and a lid 2. The lid 2 is arranged on the body portion 1. The magnetic connecting attachment 3 is arranged on the lid 2 and forms a lid assembly together with the lid 2.

The appearance of the body portion 1 is not limited in the present disclosure. The body portion 1 includes a container body 11. A cavity is formed in the container body 11 and may be used for accommodating beverage and/or food. The container body 11 is provided with an opening 111. The cavity in the container body 11 is in communication with the outside through the opening 111. A user may put the beverage and/or the food into the cavity or take same out of the cavity through the opening 111.

The lid 2 may include a top plate 21. When the lid 2 is arranged on the body portion 1, the top plate 21 may shield the opening 111 of the container body 11. The lid 2 may be detachably arranged on the body portion 1, or pivoted to the body portion 1, or integrally connected to the body portion 1, which is not limited in the present disclosure. In addition, the lid 2 is provided with an engaging feature 22 for engaging the magnetic connecting attachment 3.

The magnetic connecting attachment 3 includes a connecting member 31 and a magnetic connecting member 32. The connecting member 31 is provided with an engaging portion 311a, and the engaging portion 311a is adapted to be engaged with the engaging feature 22 of the lid 2, so that the magnetic connecting attachment 3 may be arranged on the lid 2 and is not easy to fall off. The magnetic connecting member 32 may be arranged on the connecting member 31 in a pivoted or detachable mode. The magnetic connecting member 32 is adapted to be magnetically connected to a mobile device. The mobile device may be, but is not limited to, a mobile phone, a smart watch, a Bluetooth headset, a mobile power supply, a game console, a tablet personal computer, a personal digital assistant, or an electronic book reader and the like. The mobile device has a magnetic connecting feature for magnetically connecting the magnetic connecting member 32. By taking the mobile phone as an example, the magnetic connecting feature of the mobile phone may be, for example, a MAGSAFE magnet array arranged on the mobile phone, which is not limited here.

When the user wants to fix the mobile device to the container assembly for beverages or food of this embodiment, the lid 2 may cover the opening 111 of the container body 11, and the magnetic connecting attachment 3 is engaged with the engaging feature 22 of the lid 2 through the engaging portion 311a, so that the magnetic connecting member 32 can be magnetically connected to the mobile device.

Therefore, the container assembly for beverages or food according to this embodiment has the functions of accommodating beverage or food and being used as a mobile device support and the like; and the mobile device can be stably and magnetically connected to the container assembly for beverages or food, so that the risk that the mobile device is damaged by collision can be effectively reduced. More importantly, the user only needs to carry the container assembly for beverages or food when going out, the mobile device can be stably supported when needed, a support does not need to be additionally carried for supporting the mobile device, thus the number of articles to be carried when the user goes out can be reduced, the problem that the use is inconvenient due to the fact that the user forgets to carry the support is solved, and remarkable benefits are achieved for improving the life convenience.

Specifically, with reference to FIG. 1 to FIG. 4, and in one embodiment of the present disclosure, the engaging feature 22 of the lid 2 may be optionally an engaging opening 211 that penetrates through the top plate 21. The connecting member 31 includes a main body 312. The engaging portion 311a in this embodiment may protrude out of a lower surface 3121 of the main body 312 so as to penetrate the engaging opening 211.

The engaging portion 311a may include an extending portion 3111 and a hook portion 3112. One end of the extending portion 3111 may be directly or indirectly connected to the main body 312. The hook portion 3112 may be connected to the extending portion 3111 and protrudes out of the outer circumferential surface of the extending portion 3111. In this embodiment, the hook portion 3112 is connected to the other end of the extending portion 3111. When the engaging portion 311a is connected to the engaging feature 22 (namely the engaging opening 211), the extending portion 3111 may penetrate the engaging opening 211, the hook portion 3112 may be located below the top plate 21, and therefore the magnetic connecting attachment 3 and the lid 2 are prevented from being separated.

In one embodiment of the present disclosure, the engaging portion 311a may be elastic, and therefore the engaging portion 311a is detachably connected to the engaging feature 22. For example, the extending portion 3111 may be an elastic solid or hollow column, and the hook portion 3112 may be of a barb structure continuously or intermittently distributed on the periphery of the column. Alternatively, as shown in the figure, the extending portion 3111 includes a plurality of columns (such as two columns) arranged at intervals. Free ends of the columns form a plurality of barb structures towards the opposite outer sides. The plurality of barb structures jointly form the hook portion 3112.

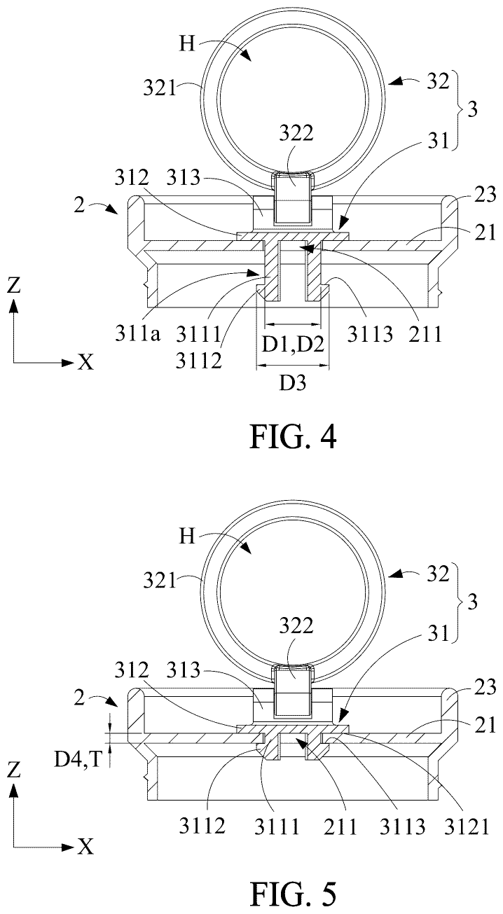

With reference to FIG. 4, before the engaging portion 311a is pressed to generate elastic deformation, an outer diameter D1 of the extending portion 3111 may be substantially equal to a caliber D2 of the engaging opening 211, and the maximum outer diameter D3 of the hook portion 3112 is larger than the caliber D2 of the engaging opening 211. Thus, when the engaging portion 311a is connected to the engaging opening 211, the engaging portion 311a may be pressed to generate elastic deformation, and the hook portion 3112 may penetrate through the engaging opening 211. After the engaging portion 311a is elastically reset, the hook portion 3112 may be located below the top plate 21, the extending portion 3111 may be approximately plugged into the engaging opening 211, and therefore leakage-proof and dustproof effects are achieved. Moreover, the magnetic connecting attachment 3 may be stably arranged on the lid 2 and is not prone to shaking.

In addition, with reference to FIG. 5, in other embodiments, a space D4 between a lower surface 3121 of the main body 312 and an upper surface 3113 of the hook portion 3112 may be selected to be substantially equal to the thickness T (especially the peripheral portion of the engaging opening 211) of the top plate 21. Thus, when the extending portion 3111 penetrates through the engaging opening 211, and the main body 312 and the hook portion 3112 are located on two opposite sides of the top plate 21 respectively, the upper surface 3113 of the hook portion 3112 may abut against a bottom side of the top plate 21, a gap is not prone to being generated between the hook portion 3112 and the lid 2, and therefore the connection stability of the magnetic connecting attachment 3 and the lid 2 is improved, and the magnetic connecting attachment 3 and the lid 2 are not prone to shaking.

On the other hand, with reference to FIG. 1, in one embodiment of the present disclosure, the top plate 21 may be, for example, a circular plate body, and the top plate 21 may also be provided with a communicating opening 212. The communicating opening 212 is adapted for a user to sip beverage in the container body 11 by mouth or a straw, or pour out the beverage in the container body 11. For example, but not limited, the engaging opening 211 may be selectively arranged at a central position of the top plate 21, and the communicating opening 212 is arranged adjacent to the periphery of the top plate 21.

In addition, the connecting member 31 in this embodiment is rotatably connected to the lid 2. For example, the engaging portion 311a may be selectively taken as a center to make the main body 312 rotate relative to the top plate 21.

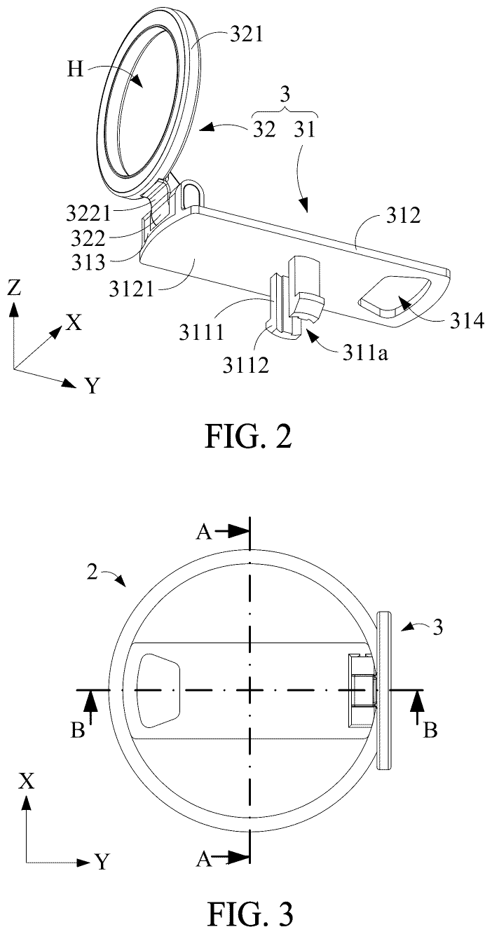

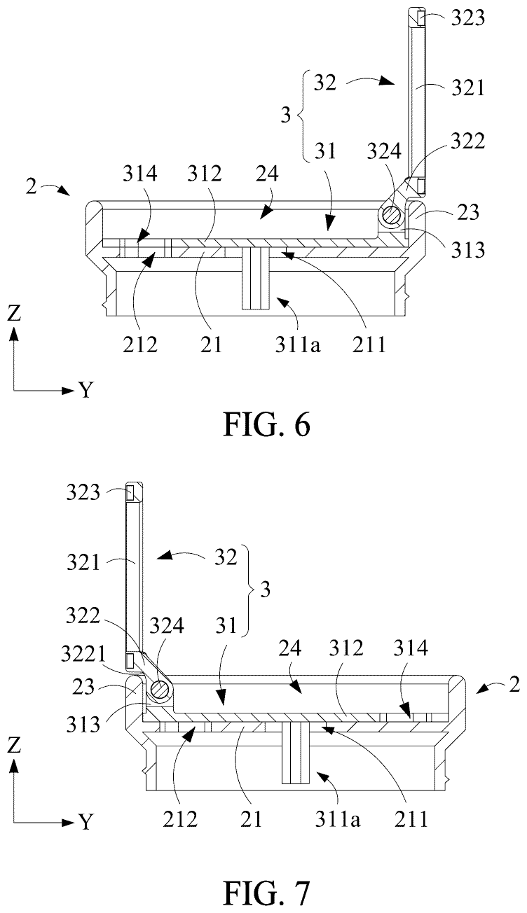

Therefore, with reference to FIG. 2 and FIG. 6, the connecting member 31 may be provided with a communicating portion 314. The communicating portion 314 may be, for example, a through hole or a plurality of small holes formed in the main body 312. In this embodiment, the main body 312 of the connecting member 31 may be in a long plate shape. The communicating portion 314 may be arranged, for example, at one end of the main body 312. When the magnetic connecting attachment 3 is arranged on the lid 2, the main body 312 of the connecting member 31 is positioned above the top plate 21. When the connecting member 31 rotates to the communicating position shown in FIG. 6 relative to the top plate 21, the communicating portion 314 may be aligned to the communicating opening 212, so that the beverage in the container body 11 may be poured out through the communicating opening 212 and the communicating portion 314; or the user may drink the beverage in the container body 11 by penetrating through the communicating portion 314 and the communicating opening 212 with the straw.

In addition, when the connecting member 31 rotates to a shielding position shown in FIG. 7 relative to the top plate 21, the main body 312 of the connecting member 31 may shield the communicating opening 212, and the communicating portion 314 is aligned with part of the top plate 21. Meanwhile, because the communicating opening 212 is shielded, outside dust or rainwater or other pollutants are not prone to entering the container body 11 through the communicating opening 212, and beverage in the container body 11 is not prone to overflowing from the communicating opening 212.

It is to be noted that no matter whether the connecting member 31 is located at the communicating position shown in FIG. 6 or the shielding position shown in FIG. 7, the state of the magnetic connecting member 32 relative to the connecting member 31 is not limited. For example, the magnetic connecting member 32 may be in a folded state or a standing state at any angle relative to the connecting member 31, and even the magnetic connecting member 32 may be detached; and it is not limited by the state disclosed in the figure.

It is also to be noted that if the user does not have the requirement for magnetically connecting the mobile device, the magnetic connecting attachment 3 may be selected not to be arranged on the lid 2, and other shielding attachments that may shield an opening formed in the lid 2 are arranged. That is, the magnetic connecting attachment 3 in this embodiment may be freely matched with the lid 2 with other types of attachments, and the use is simple and quite convenient. In addition, the magnetic connecting attachment 3 may also be arranged on other types of container for beverages or foods as long as the container for beverages or foods can be engaged with the magnetic connecting attachment 3 in this embodiment. Alternatively, the lid assembly in this embodiment can also be arranged on the body portion 1 of another container as long as the body portion 1 of the other container can be assembled to the lid 2 in this embodiment.

In addition, the main body 312 of the connecting member 31 is not limited to a long plate shape disclosed in the figure. In other possible embodiments, the main body 312 may be, for example, in a disc shape, and a groove allowing the magnetic connecting member 32 to be pivoted, folded and placed may be selectively formed in the main body 312. In other words, the present disclosure may cover a plurality of configuration types that can achieve the objectives of the present disclosure, so the present disclosure is not limited by the types disclosed in the figure.

Besides the above embodiments, with reference to FIG. 2 and FIG. 7, in one embodiment of the present disclosure, the connecting member 31 further includes a pivoting base 313, the pivoting base 313 may be connected to the main body 312, and the engaging portion 311a may be located between the pivoting base 313 and the communicating portion 314. For example, but not limited, the pivoting base 313 and the communicating portion 314 may be arranged at two ends of the main body 312 respectively. The magnetic connecting member 32 includes a magnetic connecting portion 321 and a pivoting portion 322. The magnetic connecting portion 321 is connected to the pivoting portion 322. The pivoting portion 322 is pivoted to the pivoting base 313.

The magnetic connecting portion 321 of the magnetic connecting member 32 may be of an annular structure and is provided with a through hole H. At least one magnet 323 with magnetic force or adapted to magnetic induction is arranged in the magnetic connecting portion 321. For example, but not limited, the magnetic connecting portion 321 may be, for example, in a closed circular ring shape or other polygonal ring shapes such as a triangle or a square, or may be in a C shape or a U-shaped ring shape with a notch. Preferably, the shape of the magnetic connecting portion 321 may correspond to the magnetic connecting feature on the mobile device. Through the shape correspondence of the magnetic connecting portion 321 and the mobile device, the mobile device may be more accurately and stably fixed to the magnetic connecting portion 321 in a magnetic connecting mode.

It is to be noted that in some possible embodiments, the magnetic connecting portion 321 may also include a plurality of movable elements, namely, part of the magnetic connecting portion 321 may be detached, slid, pivoted or deflected relative to other portions, such as the records of a magnetic connecting attachment 10N and a magnetic connecting attachment 10Q in US invention application Ser. No. 18/318,743. In addition, in some other embodiments, the magnetic connecting portion 321 may also be integrally formed by magnets, which is not limited in the present disclosure.

Moreover, the pivoting portion 322 of the magnetic connecting member 32 may be, for example, fixedly arranged on the magnetic connecting portion 321, but in other possible embodiments, the pivoting portion 322 and the magnetic connecting portion 321 may also be pivoted, arranged in a sliding mode or detachably assembled or in other connection relationship. The specific structure of the pivoting portion 322 may include a hinge, a universal joint, a plug-socket combination or a flexible hose and the like, which is not limited in the present disclosure.

On the other hand, with reference to FIG. 2, in some possible embodiments, the connecting member 31 may also be provided with a slide groove (not shown in the figure) in the main body 312. The slide groove may extend in the length direction (for example, a Y direction from the pivoting base 313 to the communicating portion 314 in FIG. 2), so that the pivoting base 313 is slidably arranged in the slide groove, and the position of the magnetic connecting member 32 relative to the main body 312 in the length direction can be adjusted conveniently.

In one embodiment of the present disclosure, the pivoting portion 322 may be, for example, pivoted to the pivoting base 313 of the connecting member 31 through a pivoting member 324. The pivoting member 324 may be selected as a damping hinge, a positioning gear, a ratchet wheel, or a torsional spring and other mechanical elements that can adjust the relative position in a segmented or stepless mode, so that the magnetic connecting portion 321 may be pivoted to a specific position relative to the pivoting base 313 and fixed at the position. In other words, the mobile device magnetically connected to the magnetic connecting portion 321 may be pivoted to any position along with the magnetic connecting portion 321 and is fixed, so that the requirements of the user for watching or operating the mobile device at various angles can be met.

It is to be noted that, in the embodiment where the through hole H is formed in the magnetic connecting portion 321, when the magnetic connecting portion 321 is pivoted to a phase shown in FIG. 4 or a standing state at any angle, the user may penetrate through the through hole H with fingers, and the magnetic connecting member 32 serves as a lifting handle of the container for beverages or food, so that the container for beverages or food in this embodiment can be easily taken, and the effect of improving the carrying convenience is achieved.

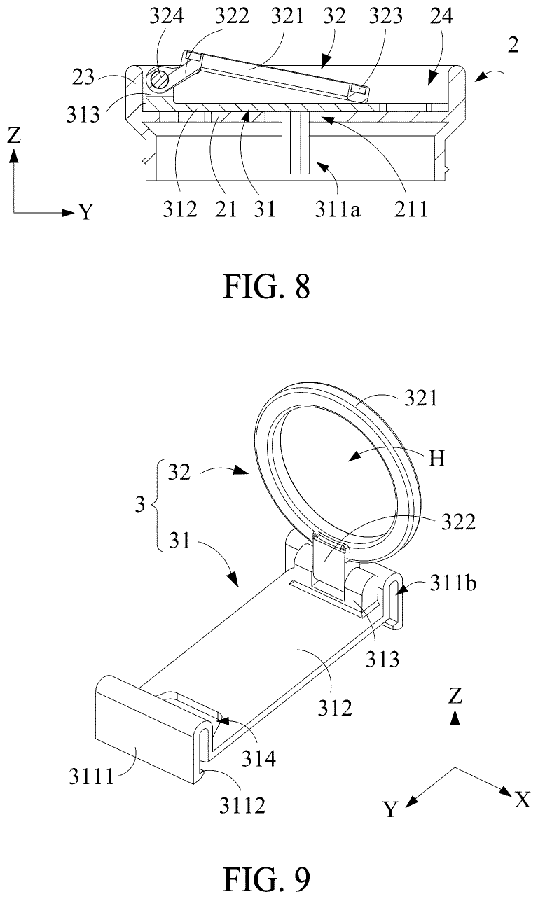

In addition to the above embodiments, with reference to FIG. 1 and FIG. 8, in one embodiment of the present disclosure, the lid 2 may additionally include a ring wall 23. The ring wall 23 is arranged at the periphery of the top plate 21. The ring wall 23 may extend a certain distance relative to the top plate 21 in the height direction (a Z direction in FIG. 1) of the container body 11. That is, the ring wall 23 may form an accommodating cavity 24 above the top plate 21 in a surrounding mode. When the magnetic connecting member 32 is pivoted to the folded state, part or all of the magnetic connecting portion 321 may be accommodated in the accommodating cavity 24, so that the magnetic connecting member 32 can be protected from being damaged by collision.

In addition to the above embodiments, with reference to FIG. 2 and FIG. 7, in one embodiment of the present disclosure, the pivoting portion 322 of the magnetic connecting member 32 may form a concave avoiding portion 3221. The concave avoiding portion 3221 is adapted to accommodate part of the ring wall 23 when the magnetic connecting portion 321 is pivoted to be adjacent to the ring wall 23. Therefore, an outer edge of the magnetic connecting portion 321 may be almost flush with an outer side surface of the ring wall 23. The mobile device can be prevented from interfering with the ring wall 23 when being adsorbed on the magnetic connecting portion 321, and the visual effect of a relatively tidy appearance can be achieved.

It is to be noted that, with reference to FIG. 1 again, although Embodiment I of the present disclosure discloses that the connecting member 31 is engaged with the engaging opening 211 of the lid 2 through the engaging portion 311a that protrudes out of the main body 312, the present disclosure is not limited thereto. In some possible embodiments, the magnetic connecting attachment 3 may also be selected to enable the length of the main body 312 to be slightly larger than the inner diameter of the ring wall 23, so that the engaging portions of the connecting member 31 may be formed at the two ends of the main body 312. Therefore, when assembling the magnetic connecting attachment 3, the main body 312 may be pressed into the ring wall 23, the two ends of the main body 312 are engaged with the inner side surface of the ring wall 23, and the effect of stably configuring the magnetic connecting attachment 3 on the lid 2 can also be achieved.

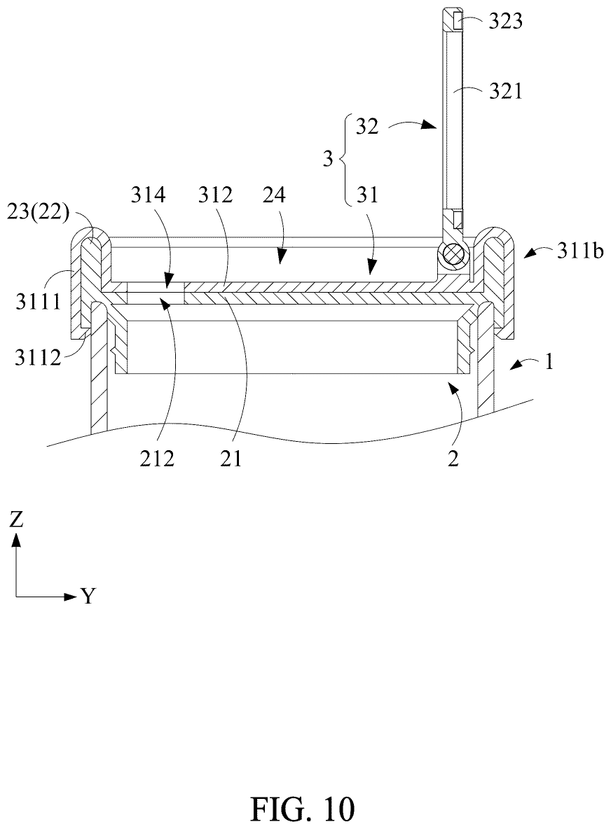

With reference to FIG. 9 and FIG. 10, which show Embodiment II of a container assembly for beverages or food and a magnetic connecting attachment 3 according to the present disclosure. This embodiment is roughly the same as Embodiment I, and the main difference is the form of the engaging portion 311b of the connecting member 31.

Specifically, in this embodiment, the engaging feature 22 of the lid 2 is formed by the ring wall 23, and the engaging portion 311b of the connecting member 31 is located at the end portion of the main body 312 and is adapted to be detachably connected to the ring wall 23.

More specifically, the engaging portion 311b may be elastic and includes an extending portion 3111 and a hook portion 3112. The extending portion 3111 is almost in an inverted U shape so as to correspond to the form of the ring wall 23. One end of the extending portion 3111 is connected to the main body 312. The hook portion 3112 is arranged at the other end of the extending portion 3111.

Therefore, when the user wants to fix the mobile device to the container assembly for beverages or food in this embodiment or wants to take the container for beverages or food through the magnetic connecting attachment 3, the lid 2 can be arranged on the body portion 1, and the magnetic connecting attachment 3 is engaged with the engaging feature 22 (the ring wall 23) of the lid 2 through the engaging portion 311b. At the moment, the extending portion 3111 may be attached to the inner side surface, the upper edge, and the outer side surface of the ring wall 23, and the hook portion 3112 may be engaged to the lower edge of the ring wall 23, so that the magnetic connecting attachment 3 can be tightly connected to the lid 2. When the user wants to drink or pour out the beverage in the container body 11, it is only needed to rotate the main body 312 and the engaging portion 311b of the connecting member 31 along the ring wall 23, and the communicating portion 314 of the connecting member 31 can be aligned to the communicating opening 212 of the top plate 21, so that the beverage in the container body 11 can be poured out through the communicating opening 212 and the communicating portion 314; or the user uses a straw to penetrate through the communicating portion 314 and the communicating opening 212 so as to drink the beverage in the container body 11, and the use is simple and very convenient.

It is to be noted that in this embodiment, although that the magnetic connecting attachment 3 includes two engaging portions 311b, and the two engaging portions 311b are arranged at the two ends of the main body 312 is taken as an example, the present disclosure is not limited thereto. The extending portion 3111 and the hook portion 3112 may be tightly connected to the ring wall 23, so that on the premise that an electronic device magnetically connected to the magnetic connecting portion 321 is kept stable, the magnetic connecting attachment 3 may also be provided with only one engaging portion 311b, or includes three, four, or more engaging portions 311b engaged to the ring wall 23, and the same effect can also be achieved.

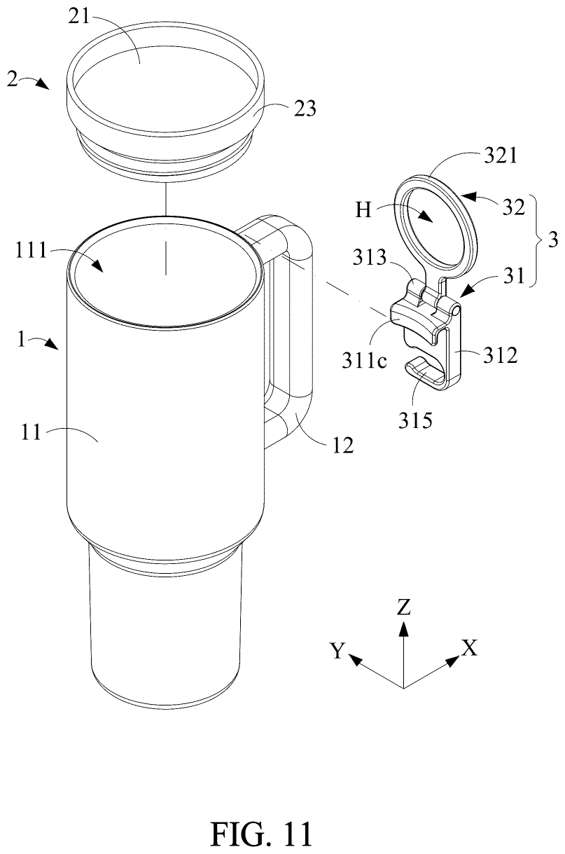

With reference to FIG. 11, it is Embodiment III of a container assembly for beverages or food and a magnetic connecting attachment 3 according to the present disclosure. This embodiment is roughly the same as the Embodiment I, the main difference is the form of the connecting member 31 of the magnetic connecting attachment 3. The magnetic connecting attachment 3 in this embodiment is adapted to be engaged with the lid 2 and the body portion 1 of the container for beverages or food at the same time.

Specifically, in this embodiment, the body portion I may include a container body 11 and a handle 12. The handle 12 is arranged on the outer side surface of the container body 11 and is adapted to the user to take the container body 11. In addition, in this embodiment, the engaging feature of the container for beverages or food may be formed by the handle 12 of the body portion 1 and the ring wall 23 of the lid 2. The magnetic connecting attachment 3 includes a connecting member 31 and a magnetic connecting member 32. The connecting member 31 includes a main body 312, a pivoting base 313, an engaging portion 311c, and a buckling portion 315. For example, the main body 312 may be a rectangular component, and the pivoting base 313 is arranged at one end of the main body 312.

With reference to FIG. 11 and FIG. 13, the engaging portion 311c is arranged on the main body 312 or the pivoting base 313. The engaging portion 311c protrudes out of a front side of the main body 312. In the side view (shown in FIG. 13), the engaging portion 311c may be almost of an inverted-L-shaped structure, and an engaging groove 316 is formed between the engaging portion 311c and the main body 312 in a surrounding mode.

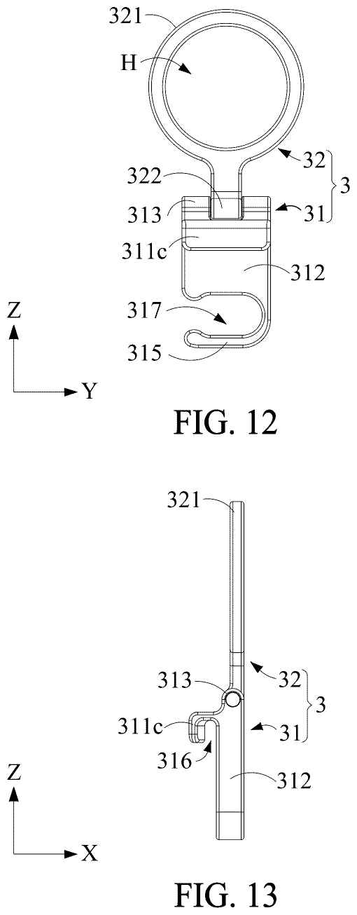

With reference to FIG. 11 and FIG. 12, the buckling portion 315 is arranged at the other end of the main body 312, and a buckling groove 317 is formed between the buckling portion 315 and the main body 312 in a surrounding mode. The opening direction of the engaging groove 316 is different from the opening direction of the buckling groove 317. In this embodiment, that the opening direction of the engaging groove 316 is downward, and the opening direction of the buckling groove 317 faces the side direction (such as the left side in FIG. 12) is taken as an example, and the present disclosure is not limited thereto.

The magnetic connecting member 32 includes a magnetic connecting portion 321 and a pivoting portion 322. The magnetic connecting portion 321 is, for example, an annular component and is provided with a through hole H. The pivoting portion 322 is, for example, formed on the outer side surface of the magnetic connecting portion 321 and is integrally formed with the magnetic connecting portion 321. The pivoting portion 322 is adapted to be pivoted to the pivoting base 313 of the connecting member 31.

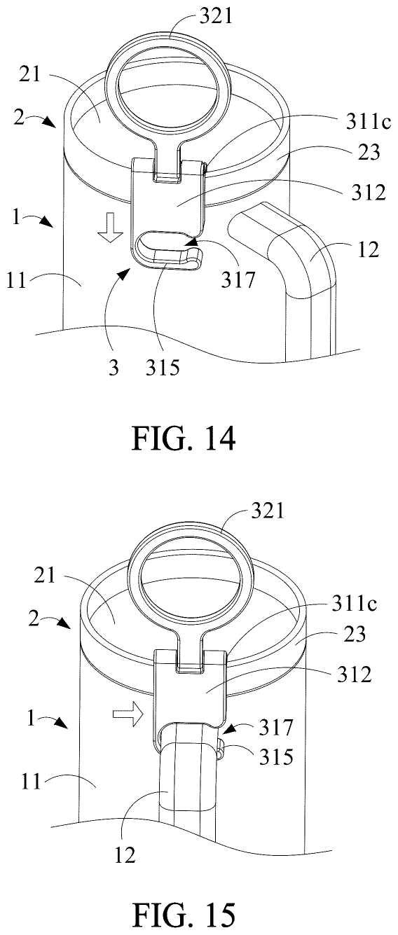

With reference to FIG. 13 and FIG. 14, when the user wants to magnetically connect the mobile device to the container assembly for beverages or food in this embodiment, the magnetic connecting attachment 3 may be buckled to the lid 2 from top to bottom in the arrow direction in FIG. 14, and the ring wall 23 of the lid 2 can interlock into the engaging groove 316.

With reference to FIG. 12 and FIG. 15, the magnetic connecting attachment 3 then slides along the ring wall 23 in the arrow direction in FIG. 15 until the handle 12 interlocks into the buckling groove 317 from the side direction, and then assembling of the magnetic connecting attachment 3, the lid 2, and the body portion 1 is finished.

Because the lower surface of the engaging groove 316 and an upper groove wall of the buckling groove 317 are abutted by the ring wall 23 and the handle 12 respectively, and a lower groove wall of the buckling groove 317 is limited by the handle 12, it can be guaranteed that the magnetic connecting attachment 3 can be tightly connected to the lid 2 and the body portion 1 in the height direction at the same time. In addition, because the opening direction of the engaging groove 316 and the opening direction of the buckling groove 317 are different, even if the magnetic connecting attachment 3 is collided by an external object or slightly disturbed, the magnetic connecting attachment 3 cannot be separated easily, and the stability of the mobile device in magnetic connection can be guaranteed.

On the other hand, because the ring wall 23 of the lid 2 is limited by the engaging portion 311c, and the handle 12 is engaged in the buckling groove 317, it can be seen as a whole that the lid 2 and the body portion 1 are clamped up and down by the magnetic connecting attachment 3, and the lid 2 and the body portion 1 cannot be separated easily.

In some possible embodiments, the buckling portion 315 may be made of an elastic material, and the buckling groove 317 may be configured to be narrow in the front and wide in the back from the opening to the interior. Through this configuration, it can be guaranteed that after the handle 12 interlocks into the buckling groove 317, the user needs to apply force slightly to disconnect the connecting member 31 from the handle 12, and therefore the connection stability of the magnetic connecting attachment 3, the lid 2, and the body portion 1 can be further improved.

The present disclosure is disclosed in the above with preferred embodiments, but those skilled in the art should understand that the embodiments are only used for describing the present disclosure and should not be construed as limiting the scope of the present disclosure. It is to be noted that all changes and substitutions equivalent to the embodiments should be in the scope of the present disclosure. Therefore, the scope of protection of the present disclosure shall be defined by claims, and the scope of the attached claims shall be interpreted in the broadest sense to include all such modifications, similar arrangements, and processes. Further, when the above several embodiments can be combined, the present disclosure contains any combination of embodiments.

What is claimed is:

1. A magnetic connecting attachment, adapted for a container for beverages or food and a mobile device, the container for beverages or food being provided with an engaging feature, the magnetic connecting attachment comprising:
a connecting member, having at least one engaging portion, the engaging portion being adapted to be engaged with the engaging feature of the container for beverages or food; and
a magnetic connecting member, arranged at the connecting member and adapted to be magnetically connected to the mobile device.

2. The magnetic connecting attachment according to claim 1, wherein the container for beverages or food is provided with a lid, and the engaging feature is arranged on the lid.

3. The magnetic connecting attachment according to claim 2, wherein the connecting member is rotatably connected to the lid, the lid comprises a top plate, the top plate is provided with a communicating opening, the connecting member comprises a main body and a communicating portion, and the main body is located above the top plate; when the connecting member rotates to a communicating position, the communicating portion is adapted to be aligned with the communicating opening; and when the connecting member rotates to a shielding position, the main body is adapted to shield the communicating opening.

4. The magnetic connecting attachment according to claim 2, wherein the lid comprises a top plate, the engaging feature is an engaging opening penetrating through the top plate, the connecting member comprises a main body, and the engaging portion protrudes out of a lower surface of the main body so as to be adapted to penetrate into the engaging opening.

5. The magnetic connecting attachment according to claim 4, wherein the engaging portion comprises an extending portion and a hook portion, one end of the extending portion is connected to the main body, and the hook portion is connected to the extending portion and protrudes out of the outer circumferential surface of the extending portion; and the extending portion penetrates through the engaging opening, and the hook portion is located below the top plate.

6. The magnetic connecting attachment according to claim 5, wherein the engaging portion is elastic and is detachably connected to the engaging feature; and before the engaging portion is pressed and elastically deformed, an outer diameter of the extending portion is substantially equal to a caliber of the engaging opening, and a maximum outer diameter of the hook portion is larger than the caliber of the engaging opening.

7. The magnetic connecting attachment according to claim 5, wherein a space between a lower surface of the main body and an upper surface of the hook portion is substantially equal to the thickness of the top plate.

8. The magnetic connecting attachment according to claim 2, wherein the connecting member comprises a main body and a pivoting base; the pivoting base is connected to the main body; and the magnetic connecting member comprises a magnetic connecting portion and a pivoting portion, the magnetic connecting portion is connected to the pivoting portion, and the pivoting portion is pivoted to the pivoting base.

9. The magnetic connecting attachment according to claim 8, wherein the lid comprises a top plate and a ring wall, the ring wall is arranged on the periphery of the top plate, and the ring wall forms an accommodating cavity above the top plate in a surrounding mode; and when the magnetic connecting member is pivoted to a folded state, part or all of the magnetic connecting portion is accommodated in the accommodating cavity.

10. The magnetic connecting attachment according to claim 8, wherein the lid comprises a top plate and a ring wall, and the ring wall is arranged on the periphery of the top plate; and the pivoting portion forms a concave avoiding portion which is adapted to accommodate the ring wall when the magnetic connecting portion is pivoted to be adjacent to the ring wall.

11. The magnetic connecting attachment according to claim 8, wherein the main body is provided with a slide groove, and the pivoting base is slidably arranged in the slide groove.

12. The magnetic connecting attachment according to claim 2, wherein the lid comprises a top plate and a ring wall, and the ring wall is arranged on the periphery of the top plate; and the connecting member comprises a main body, and two ends of the main body form the engaging portion to be engaged with an inner side surface of the ring wall.

13. The magnetic connecting attachment according to claim 2, wherein the lid comprises a top plate and a ring wall, and the ring wall is arranged on the periphery of the top plate and forms the engaging feature of the lid; and the connecting member comprises a main body, and the engaging portion is located at an end portion of the main body and adapted to be detachably connected to the ring wall.

14. The magnetic connecting attachment according to claim 13, wherein the engaging portion is elastic and comprises an extending portion and a hook portion, the extending portion is in an inverted U shape corresponding to the form of the ring wall, one end of the extending portion is connected to the main body, and the hook portion is arranged at the other end of the extending portion.

15. The magnetic connecting attachment according to claim 14, wherein when the engaging portion is connected to the ring wall, the extending portion is attached to an inner side surface, an upper edge, and an outer side surface of the ring wall, and the hook portion is engaged to a lower edge of the ring wall.

16. The magnetic connecting attachment according to claim 1, wherein the container for beverages or food comprises a body portion and a lid; the lid is adapted to be arranged on the body portion, and the body portion comprises a handle; the lid comprises a top plate and a ring wall, the ring wall is arranged on the periphery of the top plate, and the handle and the ring wall jointly form the engaging feature; the connecting member comprises a main body, a pivoting base, an engaging portion, and a buckling portion, the pivoting base is arranged on the main body, the engaging portion is arranged on the main body or the pivoting base, an engaging groove is formed between the engaging portion and the main body in a surrounding mode, and the engaging groove is adapted to allow the ring wall to interlock; and the buckling portion is arranged on the main body, a buckling groove is formed between the buckling portion and the main body in a surrounding mode, the buckling groove is adapted to allow the handle to interlock, and the opening direction of the engaging groove is different from that of the buckling groove.

17. The magnetic connecting attachment according to claims 1, wherein the magnetic connecting member comprises a magnetic connecting portion, and the magnetic connecting portion is of an annular structure and forms a through hole.

18. The magnetic connecting attachment according to claims 1, wherein the magnetic connecting member comprises a magnetic connecting portion, and the shape of the magnetic connecting portion corresponds to a magnetic connecting feature of the mobile device.

19. A lid assembly, adapted for a mobile device, comprising:
a lid, having an engaging feature; and
a magnetic connecting attachment, comprising:
a connecting member, having at least one engaging portion, the engaging portion being adapted to be engaged with the engaging feature of the lid; and
a magnetic connecting member, arranged at the connecting member and adapted to be magnetically connected to the mobile device.

20. The lid assembly according to claim 19, wherein the connecting member is rotatably connected to the lid, the lid comprises a top plate, the top plate is provided with a communicating opening, the connecting member comprises a main body and a communicating portion, and the main body is located above the top plate; when the connecting member rotates to a communicating position, the communicating portion is aligned with the communicating opening; and when the connecting member rotates to a shielding position, the main body shields the communicating opening.

21. The lid assembly according to claim 19, wherein the lid comprises a top plate, the engaging feature is an engaging opening penetrating through the top plate, the connecting member comprises a main body, and the engaging portion protrudes out of a lower surface of the main body so as to be adapted to penetrate into the engaging opening.

22. The lid assembly according to claim 21, wherein the engaging portion comprises an extending portion and a hook portion, one end of the extending portion is connected to the main body, and the hook portion is connected to the extending portion and protrudes out of the outer circumferential surface of the extending portion; and the extending portion penetrates through the engaging opening, and the hook portion is located below the top plate.

23. The lid assembly according to claim 22, wherein the engaging portion is elastic and is detachably connected to the engaging feature; and before the engaging portion is pressed and elastically deformed, an outer diameter of the extending portion is substantially equal to a caliber of the engaging opening, and a maximum outer diameter of the hook portion is larger than the caliber of the engaging opening.

24. The lid assembly according to claim 22, wherein a space between a lower surface of the main body and an upper surface of the hook portion is substantially equal to the thickness of the top plate.

25. The lid assembly according to claim 19, wherein the connecting member comprises a main body and a pivoting base; the pivoting base is connected to the main body; and the magnetic connecting member comprises a magnetic connecting portion and a pivoting portion, the magnetic connecting portion is connected to the pivoting portion, and the pivoting portion is pivoted to the pivoting base.

26. The lid assembly according to claim 25, wherein the lid comprises a top plate and a ring wall, the ring wall is arranged on the periphery of the top plate, and the ring wall forms an accommodating cavity above the top plate in a surrounding mode; and when the magnetic connecting member is pivoted to a folded state, part or all of the magnetic connecting portion is accommodated in the accommodating cavity.

27. The lid assembly according to claim 25, wherein the lid comprises a top plate and a ring wall, and the ring wall is arranged on the periphery of the top plate; and the pivoting portion forms a concave avoiding portion which is adapted to accommodate the ring wall when the magnetic connecting portion is pivoted to be adjacent to the ring wall.

28. The lid assembly according to claim 19, wherein the lid comprises a top plate and a ring wall, and the ring wall is arranged on the periphery of the top plate; and the connecting member comprises a main body, and two ends of the main body form the engaging portion to be engaged with an inner side surface of the ring wall.

29. The lid assembly according to claim 19, wherein the lid comprises a top plate and a ring wall, and the ring wall is arranged on the periphery of the top plate and forms the engaging feature of the lid; and the connecting member comprises a main body, and the engaging portion is located at an end portion of the main body and adapted to be detachably connected to the ring wall.

30. The lid assembly according to claim 29, wherein the engaging portion is elastic and comprises an extending portion and a hook portion, the extending portion is in an inverted U shape corresponding to the form of the ring wall, one end of the extending portion is connected to the main body, and the hook portion is arranged at the other end of the extending portion.

31. The lid assembly according to claim 30, wherein when the engaging portion is connected to the ring wall, the extending portion is attached to an inner side surface, an upper edge, and an outer side surface of the ring wall, and the hook portion is engaged to a lower edge of the ring wall.

32. The lid assembly according to claim 19, wherein the lid is adapted to be arranged on a body portion of a container for beverages or food, and the body portion comprises a handle; the lid comprises a top plate and a ring wall, and the ring wall is arranged on the periphery of the top plate; the connecting member comprises a main body, a pivoting base, an engaging portion, and a buckling portion, the pivoting base is arranged on the main body, the engaging portion is arranged on the main body or the pivoting base, an engaging groove is formed between the engaging portion and the main body in a surrounding mode, and the engaging groove is adapted to allow the ring wall to interlock; and the buckling portion is arranged on the main body, a buckling groove is formed between the buckling portion and the main body in a surrounding mode, the buckling groove is adapted to allow the handle to interlock, and the opening direction of the engaging groove is different from that of the buckling groove.

33. A container assembly for beverages or food, adapted to a mobile device, comprising:
a container for beverages or food, having an engaging feature; and
a magnetic connecting attachment, comprising:
a connecting member, having at least one engaging portion, the engaging portion being adapted to be engaged with the engaging feature of the container for beverages or food; and
a magnetic connecting member, arranged at the connecting member and adapted to be magnetically connected to the mobile device.

34. The container assembly for beverages or food according to claim 33, wherein the container for beverages or food is provided with a body portion and a lid, the lid is adapted to be arranged on the body portion, and the engaging feature is arranged on the lid.
